(19) United States
(12) Patent Application Publication
(10) Pub. No.: US 2026/0005952 A1
(43) Pub. Date: Jan. 1, 2026

(54) UAV NETWORK SYSTEM AND OPTIMIZING METHOD OF PACKET TRANSMISSION PATH

(71) Applicant: Luxshare Precision Industry Company Limited, Shenzhen (CN)

(72) Inventors: Guan Hsiung WANG, Shenzhen (CN); Wei Hsin CHEN, Shenzhen (CN)

(21) Appl. No.: 19/098,089

(22) Filed: Apr. 2, 2025

(30) Foreign Application Priority Data
Jun. 27, 2024 (CN) 2024108523059

(51) Int. Cl. H04L 45/121; H04L 67/12; H04W 24/02; H04W 84/06

(52) U.S. Cl. CPC H04L 45/121; H04L 67/12; H04W 24/02; H04W 84/06

(57) ABSTRACT

A UAV network system and an optimizing method of packet transmission path are provided, and the optimizing method of packet transmission path is performed by the UAV network system. The optimizing method of packet transmission path includes: receiving a target packet and obtaining a target base station from the target packet; transmitting a test packet to a first class child UAV second class child UAVs to obtain a first response signal and second response signals; according to the first response signal and the second response signals, generating a first response time and second response times; according to the first response time and the second response times, selecting at least one from the second class child UAVs as a travel point, and creating a travel list including the travel point; according to the travel list, transmitting the target packet to the target base station.

### CROSS-REFERENCE TO RELATED APPLICATIONS

This application claims the priority benefit of Chinese Patent Application Serial Number 2024108523059, filed on Jun. 27, 2024, the full disclosure of which is incorporated herein by reference.

### TECHNICAL FIELD OF THE INVENTION

The present disclosure is related to a technical field of communication and is particularly related to an UAV network system and an optimizing method of a packet transmission path.

### DESCRIPTION OF THE PRIOR ART

An unmanned aerial vehicle (UAV) is a radio-controlled aircraft without any pilot on board. The UAV is manipulated by radio-controlled technologies, autopilot or self-driving so that the UAV has numerous advantages such as high maneuverability, small size and low cost and is widely used in many application fields such as scientific research, site investigation, disaster assistance, farm monitoring and militaries.

When the UAVs are applied to disaster relief, but base stations are sequentially collapsed or a communication network is abnormal, the UAVs immediately shoot disaster relief videos and transform the disaster relief videos into video packets but are unable to immediately transmit the video packets to the base station where disaster relief workers are located by the base stations due to the collapse of the base stations. Hence, how to utilize the UAVs to constitute a UAV network and how to perform the immediate transmission of the video packets by the UAV network are important issues.

### SUMMARY

In light of the aforementioned descriptions, the present disclosure provides an UAV network system and an optimizing method of a packet transmission path to solve the problem that the video packets can not be immediately transmitted due to the sequential collapse of the base stations and the abnormal communication network.

Based on the aforementioned descriptions, the present disclosure is to provide the UAV network system. The UAV network system includes a child UAV group and a mother UAV, and the child UAV group includes a first class child UAV and a plurality of second class child UAVs. The first class child UAV receives a target packet, and the first class child UAV and the plurality of second class child UAVs are wirelessly connected to each other. The mother UAV is wirelessly connected to the first class child UAV and the plurality of second class child UAVs, and obtains a target base station from the target packet by the first class child UAV. The mother UAV performing steps as follows: transmitting a test packet to the first class child UAV and the plurality of second class child UAVs and obtaining a first response signal and a plurality of second response signals from the first class child UAV and the plurality of second class child UAVs; according to the first response signal and the plurality of second response signals, generating a first response time and a plurality of second response times; according to the first response time and the plurality of second response times, selecting at least one from the plurality of second class child UAVs as a travel point, and creating a travel list including the travel point based on the target base station and the first class child UAV; according to the travel list, transmitting the target packet to the target base station.

Based on the aforementioned descriptions, the present disclosure is to provide the UAV network system. The UAV network system includes a plurality of child UAVs and a mother UAV. The plurality of child UA Vs are wirelessly connected to each other. The mother UAV is wirelessly connected to the plurality of child UAVs, receives a target packet and obtains a target base station from the target packet. The mother UAV performs steps as follows: transmitting a test packet to the plurality of child UAVs and obtaining a plurality of response signals from the plurality of child UAVs; according to the plurality of response signals, generating a plurality of response times; according to the plurality of response times, selecting at least one from the plurality of child UAVs as a travel point, and creating a travel list including the travel point based on the target base station and the mother UAV; according to the travel list, transmitting the target packet to the target base station.

Based on the aforementioned descriptions, the present disclosure is to provide the optimizing method of the packet transmission path adapted to a UAV network system. The UAV network system includes a child UAV group and a mother UAV, and the child UAV group includes a first class child UAV and a plurality of second class child UAVs. The optimizing method of the packet transmission path performed by the mother UAV includes: receiving a target packet by the first class child UAV and obtaining a target base station from the target packet; transmitting a test packet to the first class child UAV and the plurality of second class child UAVs and obtaining a first response signal and a plurality of second response signals from the first class child UAV and the plurality of second class child UAVs; according to the first response signal and the plurality of second response signals, generating a first response time and a plurality of second response times; according to the first response time and the plurality of second response times, selecting at least one from the plurality of second class child UAVs as a travel point, and creating a travel list including the travel point based on the target base station and the first class child UAV; according to the travel list, transmitting the target packet to the target base station.

Based on the aforementioned descriptions, the present disclosure is to provide the optimizing method of the packet transmission path adapted to a UAV network system. The UAV network system includes a plurality of child UAVs and a mother UAV. The optimizing method of the packet transmission path performed by the mother UAV includes: receiving a target packet and obtaining a target base station from the target packet; transmitting a test packet to plurality of child UAVs and obtaining a plurality of response signals from the plurality of child UAVs; according to the plurality of response signals, generating a plurality of response times; according to the plurality of response times, selecting at least one from the plurality of child UAVs as a travel point, and creating a travel list including the travel point based on the target base station and the mother UAV; according to the travel list, transmitting the target packet to the target base station.

In view of the above description, the UAV network system and the optimizing method of the packet transmission path selects at least one child UAV as the travel point according to the plurality of response times which the plurality of child UAVs takes for responding to the mother UAV, creates the travel list according to the travel point and the child UAV receiving the packet or the mother UAV and transmits the packets to a destination according to the travel point of the travel list. By the configuration of the travel list, the entire power dissipation of the UAV group may be reduced, and the immediate transmission of the packets may be implemented.

In addition, the UAV network system and the optimizing method of the packet transmission path may be applied to a disaster relief environment so that the base station where disaster relief workers are located may access the situation of the disaster relief environment.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1 depicts a configuration diagram of a UAV network system according to one embodiment of the present disclosure.

FIG. 2 depicts a configuration diagram of a UAV network system according to another embodiment of the present disclosure.

FIG. 3 depicts a flowchart of an optimizing method of a packet transmission path according to one embodiment of the present disclosure.

FIG. 4 depicts a flowchart of detailed steps of selecting travel points according to one embodiment of the present disclosure.

FIG. 5 depicts a flowchart of detailed steps of a selection procedure according to one embodiment of the present disclosure.

FIG. 6 depicts a schematic diagram of a travel list according to one embodiment of the present disclosure.

FIG. 7A and FIG. 7B depict a flowchart of an optimizing method of a packet transmission path according to another embodiment of the present disclosure.

FIG. 8 depicts a flowchart of an optimizing method of a packet transmission path according to yet another embodiment of the present disclosure.

FIG. 9 depicts a flowchart of detailed steps of selecting travel points according to yet another embodiment of the present disclosure.

FIG. 10 depicts a schematic diagram of a travel list according to yet another embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely one part of the embodiments of the present disclosure and not all embodiments of the present disclosure. Based on the embodiments of the present disclosure, all embodiments obtained by a person skilled in the art without any inventive steps shall fall within the scope of protection of the present disclosure.

It should be noted that the terms “first”, “second”, etc. in the specification and claims of the present disclosure and in the aforementioned accompanying drawings are used to distinguish similar objects and not used to describe a particular order or sequence. Furthermore, the terms “comprising” and “having”, and any variation thereof, are intended to encompass a non-exclusive inclusion, for example, a series of steps or units comprising processes, methods, systems, products or equipment do not need to be limited to those steps or units clearly listed but may include other steps or units not clearly listed or inherent to those processes, methods, products or equipment.

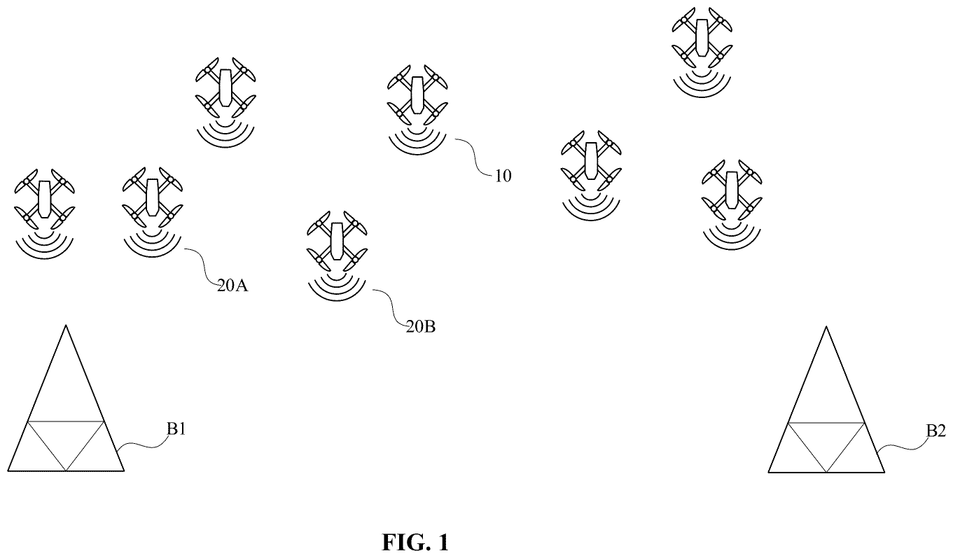

Please refer to FIG. 1, which depicts a configuration diagram of a UAV network system according to one embodiment of the present disclosure. As shown in FIG. 1, a UAV network system includes a child UAV group and a mother UAV 10. The child UAV group includes a first class child UAV 20A and a plurality of second class child UAVs 20B, the first class child UAV 20A receives a target packet, and the first class child UAV 20A and the plurality of second class child UAVs 20B are wirelessly connected to each other. The mother UAV 10 is wirelessly connected to the first class child UAV 20A and the plurality of second class child UAVs 20B, and obtains a target base station B2 from the target packet by the first class child UAV 20A.

The mother UAV 10, the first class child UAV 20A and the plurality of second class child UAVs 20B collaboratively constitute a UAV network, the UAV network serves as a wireless relay network, and the mother UAV 10, the first class child UAV 20A and the plurality of second class child UAVs 20B are disposed on the plurality of network nodes of the UAV network and serve as relay stations. The UAV network belongs to 5G IoT and can be connected to 5G base stations, and the signal coverage range of the UAV network is wider than the signal coverage range of the mother UAV 10.

It should be noted that the mother UAV 10, the first class child UAV 20A and the plurality of second class child UAVs 20B have functions of capturing images, positioning, wireless communication, sensing sound and sensing temperature, i.e., the functions which the mother UAV 10, the first class child UAV 20A and the plurality of second class child UAVs 20B are provided with are the same as the functions which the current UAV is provided with. Certainly, the functions of the mother UAV 10, the first class child UAV 20A and the plurality of second class child UAVs 20B may add other functions (e.g., sensing humidity) according to actual application requirements but not be limited thereto. The first class and the second class are types for distinguishing the child UAV which receives the target packet and the child UAV which transfers the target packet instead of limiting the present disclosure.

In the present embodiment, the mother UAV 10 transmits a test packet to each of the plurality of second class child UAVs 20B, each of the plurality of second class child UAVs 20B transmits a second response signal to the mother UAV 10, and the mother UAV 10 calculates the receiving times corresponding to the plurality of second class child UAVs 20B. The mother UAV 10 receives a test signal from a source base station B1 to obtain a timestamp and calculates the distance and the time difference between the mother UAV 10 and the source base station B1 according to the timestamp; hence, the mother UAV 10 calculates the receiving time corresponding to the source base station B1 according to the timestamp. Afterwards, the mother UAV 10 selects one from the plurality of second class child UAVs 20B as the first class child UAV 20A according to the receiving times corresponding to the plurality of second class child UAVs 20B and the receiving time corresponding to the source base station B1, and the response signal of the first class child UAV 20A is a first response signal; the mother UAV 10 controls the first class child UAV 20A to receive the target packet from the source base station B1 and obtains the target base station B2 corresponding to the target packet from the first class child UAV 20A. Thereafter, the mother UAV 10 calculates a first response time and a plurality of second response times according to the first response signal and the plurality of second response signals, and the calculation details of the first response time and the plurality of second response times will be explained in the paragraphs of an optimizing method of a packet transmission path.

It should be noted that the source base station B1 is the packet transmission starting point belonging to a transmitter side to transmit the target packet to the first class child UAV 20A; the target base station B2 is the packet transmission ending point belonging to a receiver side to receive the target packet from the UAV network. The test packet is the packet for communication or handshaking to examine the network connection of the first class child UAV 20A, the plurality of second class child UAVs 20B and the mother UAV 10.

In another embodiment, the first class child UAV 20A performs image capture and sound detection on the surrounding environments thereof to generate video data and generates the target packet according to the video data, the target base station B2 is previously set on the first class child UAV 20A, and the mother UAV 10 obtains the target base station B2 corresponding to the target packet from the first class child UAV 20A. The mother UAV 10 transmits the test packet to the first class child UAV 20A and the plurality of second class child UAVs 20B, receive the first response signal and the plurality of second response signals from the first class child UAV 20A and the plurality of second class child UAVs 20B, and calculates the first response time and the plurality of second response times according to the first response signal and the plurality of second response signals.

Finally, the mother UAV 10 selects at least one from the plurality of second class child UAVs 20B as an auxiliary UAV and creates a travel list according to the auxiliary UAV, the first class child UAV 20A and the target base station B2, and the target packet is transmitted to the target base station B2 by the travel list. The travel list includes a plurality of travel points, the auxiliary UAVs helps the first class child UAV 20A transmit the target packet to the target base station B2, and all the auxiliary UAVs and the first class child UAV 20A serve as the plurality of travel points of the travel list. How to select the auxiliary UAVs according to the first response time and the plurality of second response times and to create the travel list will be explained in the paragraphs of an optimizing method of a packet transmission path.

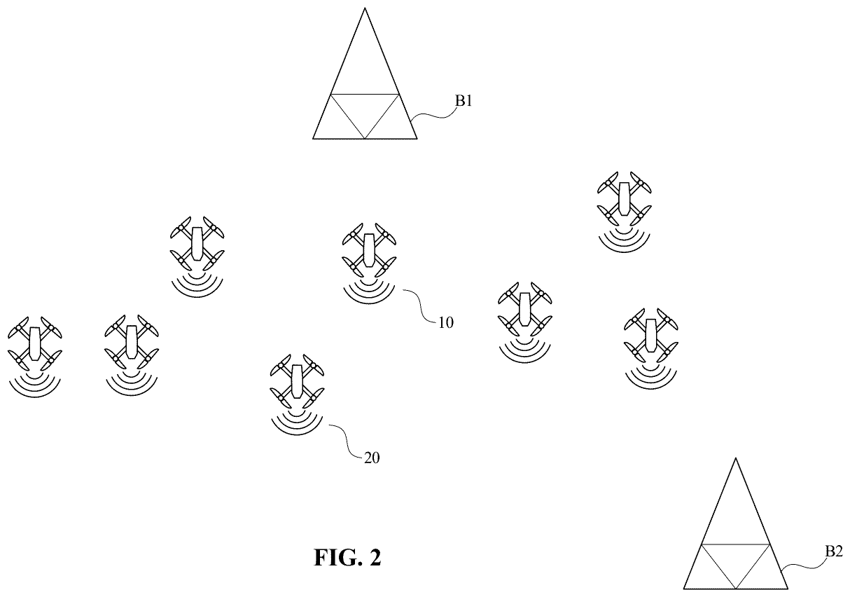

Please refer to FIG. 2, which depicts a configuration diagram of a UAV network system according to another embodiment of the present disclosure. As shown in FIG. 2, the UAV network system includes a plurality of child UAVs 20 and a mother UAV 10. In the present embodiment, the mother UAV 10 receives the target packet and obtains the target base station B2 from the target packet, or the mother UAV 10 performs the image capture and the sound detection on the surrounding environments thereof to generate video data and generates the target packet according to the video data, and the target base station B2 is previously set on the mother UAV 10. The plurality of child UAVs 20 assist in transmitting the target packet to the target base station B2, and there is no need to classify the plurality of child UAVs 20 as the first class and the second class. The configuration of the mother UAV 10 shown in FIG. 2 is the same as the configuration of the mother UAV 10 shown in FIG. 1, the configurations of the plurality of child UAVs 20 shown in FIG. 2 is the same as the configurations of the plurality of second class child UAVs 20B shown in FIG. 1, and the configurations of the mother UAV 10 and the plurality of child UAVs 20 shown in FIG. 2 would not be repeated.

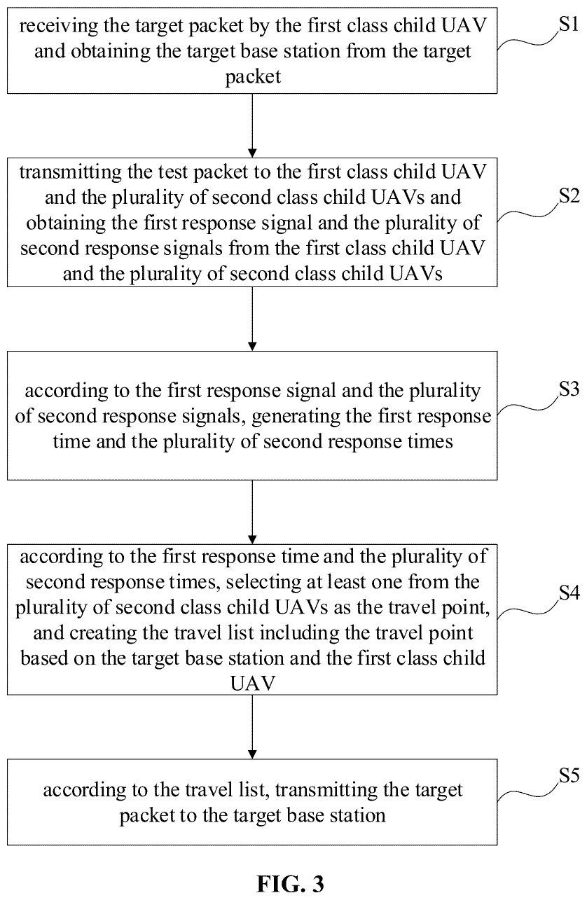

Please refer to FIG. 3, which depicts a flowchart of an optimizing method of a packet transmission path according to one embodiment of the present disclosure. As shown in FIG. 3, an optimizing method of a packet transmission path includes step S1˜step S5. The optimizing method of the packet transmission path shown in FIG. 3 may be applicable to the UAV network system shown in FIG. 1 but is not limited thereto. For example, step S1˜step S5 would be explained by the UAV network system shown in FIG. 1 as follows.

Step S1: receiving the target packet by the first class child UAV 20A and obtaining the target base station B2 from the target packet. As described above, the first class child UAV 20A receives the target packet of the source base station B1 or generates the target packet according to the video data, and the mother UAV 10 obtains the target base station B2 from the first class child UAV 20A.

Step S2: transmitting the test packet to the first class child UAV 20A and the plurality of second class child UAVs 20B and obtaining the first response signal and the plurality of second response signals from the first class child UAV 20A and the plurality of second class child UAVs 20B. As described above, the mother UAV 10 transmits the test packet to the first class child UAV 20A and the plurality of second class child UAVs 20B, the first class child UAV 20A and the plurality of second class child UAVs 20B respectively transmit the first response signal and the plurality of second response signals to the mother UAV 10 in response to the mother UAV 10, and the mother UAV 10 ensures the network connection of the first class child UAV 20A and the plurality of second class child UAVs 20B according to the first response signal and the plurality of second response signals.

Step S3: according to the first response signal and the plurality of second response signals, generating the first response time and the plurality of second response times. Specifically, the time point when the mother UAV 10 transmits the test packet is a transmission time point, the time point when the mother UAV 10 receives the first response signal and the plurality of time points when the mother UAV 10 receives the plurality of second response signals are a first receiving time point and a plurality of second receiving time points. The mother UAV 10 performs the subtraction on the first receiving time point and the transmission time point to generate the first response time and performs the subtraction on the plurality of second receiving time points and the transmission time point respectively to generate the plurality of second response times.

Step S4: according to the first response time and the plurality of second response times, selecting at least one from the plurality of second class child UAVs 20B as the travel point, and creating the travel list including the travel point based on the target base station B2 and the first class child UAV 20A. Specifically, the first class child UAV 20A is a first travel point (i.e., the starting point of the travel list). The mother UAV 10 selects one from the plurality of second class child UAVs 20B as a second travel point according to the first response time of the first travel point, and selects one from the plurality of second class child UAVs 20B except the second travel point as a third travel point according to the second response time of the second travel point. Afterwards, the mother UAV 10 selects one from the plurality of second class child UAVs 20B except the second travel point and the third travel point as a fourth travel point according to the second response time of the third travel point, and the selection mechanisms of a fifth travel point to a last travel point are the same as the selection mechanisms of the second travel point to the fourth travel point and would not be repeated. Finally, the mother UAV 10 determines whether the signal coverage range of the last travel point includes the target base station B2. When determining that the signal coverage range of the last travel point includes the target base station B2, the mother UAV 10 determines the last travel point as the ending point of the transmission path of the target packet and creates the travel list according to the first travel point to the last travel point (i.e., the ending point of the travel list); when determining that the signal coverage range of the last travel point does not include the target base station B2, the mother UAV 10 determines that the last travel point is not the ending point of the transmission path of the target packet and still performs the selection of the travel points.

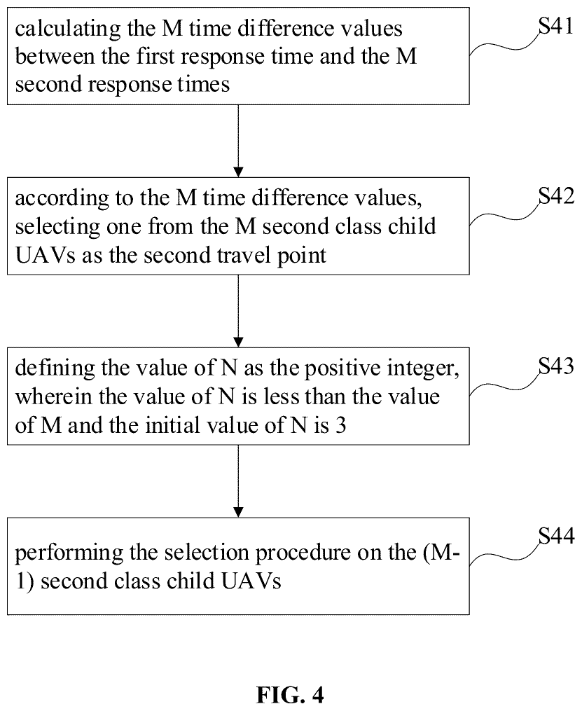

Furthermore, the mother UAV 10 selects a current travel point (e.g., the third travel point) according to the response time of the previous travel point (e.g., the second travel point) and selects a next travel point (e.g., fourth travel point) according to the response time of the current travel point until the mother UAV 10 selects and ensures that the signal coverage range of the last travel point includes the target base station B2. When determining that the transmission path of the target packet is complete, the mother UAV 10 creates the travel list according to the first travel point to the last travel point. Please refer to FIG. 4, which depicts a flowchart of detailed steps of selecting travel points according to one embodiment of the present disclosure. As shown in FIG. 4, the detailed steps of selecting the travel points includes step S41˜step S44, and step S41˜step S44 are performed by the mother UAV 10. Herein, the number of the plurality of second class child UAVs 20B is M, the value of M is defined as a positive integer, and the travel list includes N travel points.

Step S41: calculating the M time difference values between the first response time and the M second response times. Specifically, the mother UAV 10 performs the subtraction on the first response time of the first travel point and the M second response times of the M second class child UAVs 20B to generate the M time difference values.

Step S42: according to the M time difference values, selecting one from the M second class child UAVs as the second travel point. In one embodiment, the mother UAV 10 selects the minimum time difference value from the M time difference values and regards the second class child UAV 20B corresponding to the minimum time difference value as the second travel point. In another embodiment, the mother UAV 10 has a preset value and compares each of the M time difference values with the preset value. When the time difference value is less than the preset value, the mother UAV 10 retains the second class child UAV 20B that the time difference value is less than the preset value; when the time difference value is not less than the preset value, the mother UAV 10 excludes the second class child UAV 20B that the time difference value is not less than the preset value. Afterwards, the mother UAV 10 selects the minimum time difference value from the at least one time difference value less than the preset value and regards the second class child UAV 20B corresponding to the minimum time difference value as the second travel point.

Step S43: defining the value of N as the positive integer, wherein the value of N is less than the value of M and the initial value of N is 3. In light of the configuration of the first travel point and the second travel point, the mother UAV 10 performs the selection of the travel points from the third travel point.

Step S44: performing the selection procedure on the (M-1) second class child UAVs 20B. Because the second travel point is selected at step S42, the number of the M second class child UAVs 20B is subtracted by 1. The mother UAV 10 performs the selection procedure on each of the (M-1) second class child UAVs 20B to select the third travel point to the Nth travel point from the (M-1) second class child UAVs 20B.

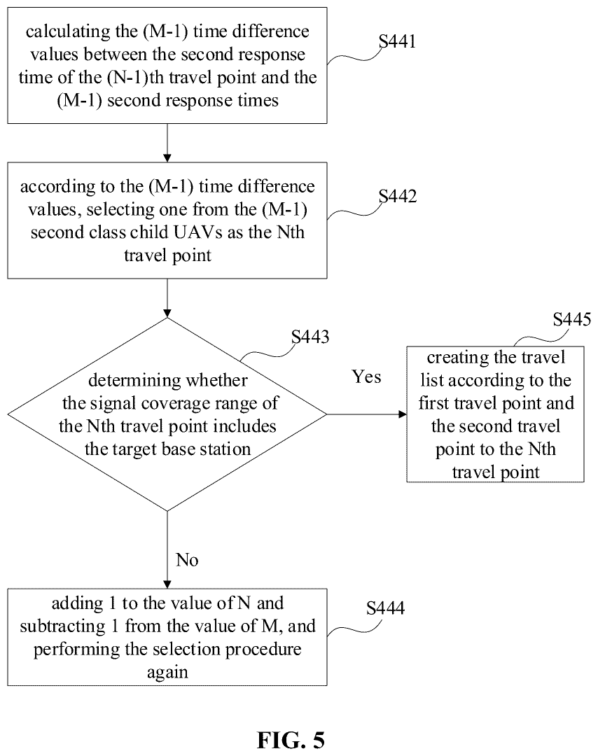

The selection procedure would be exemplarily explained as follows. Please refer to FIG. 5, which depicts a flowchart of detailed steps of a selection procedure according to one embodiment of the present disclosure. As shown in FIG. 5, the selection procedure includes step S441˜step S445, and step S441˜step S445 are performed by the mother UAV 10.

Step S441: calculating the (M-1) time difference values between the second response time of the (N-1)th travel point and the (M-1) second response times. Specifically, the mother UAV 10 respectively performs the subtraction on the second response time of the (N-1)th travel point (i.e., the previous travel point) and the (M-1) second response times of the (M-1) second class child UAVs 20B to generate the (M-1) time difference values.

Step S442: according to the (M-1) time difference values, selecting one from the (M-1) second class child UAVs 20B as the Nth travel point. Specifically, the mother UAV 10 selects the minimum time difference value from the (M-1) time difference values and regards the second class child UAV 20B corresponding to the minimum time difference value as the Nth travel point, and the Nth travel point is the current travel point.

Step S443: determining whether the signal coverage range of the Nth travel point includes the target base station B2. Specifically, the mother UAV 10 determines whether the signal coverage range of each travel point includes the target base station B2 to ensure whether the current travel point is the last relay station of the transmission path of the target packet.

When determining that the signal coverage range of the Nth travel point includes the target base station B2, the mother UAV 10 ensures that the current travel point is the last relay station of the transmission path of the target packet and subsequently performs step S445. When determining that the signal coverage range of the Nth travel point does not include the target base station B2, the mother UAV 10 ensures that the current travel point is not the last relay station of the transmission path of the target packet and subsequently performs step S444.

Step S444: adding 1 to the value of N and subtracting 1 from the value of M, and performing the selection procedure again. Because the current travel point is selected at step S442, the mother UAV 10 goes back to step S441 and performs step S441 again to select the next travel point according to the current travel point.

Step S445: creating the travel list according to the first travel point and the second travel point to the Nth travel point. Specifically, the mother UAV 10 ensures that the Nth travel point is the last travel point of the travel list, creates the transmission path of the target packet according to the first travel point and the second travel point to the Nth travel point and writes the transmission path of the target packet into the travel list.

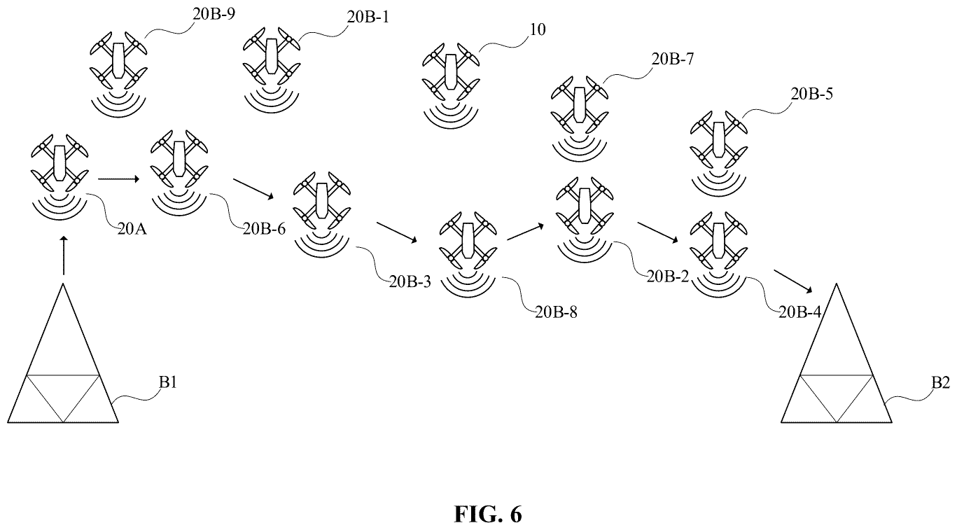

For example, as shown in FIG. 6, M=9, the nine second class child UAVs 20B are a second class first child UAV 20B-1, a second class second child UAV 20B-2, a second class third child UAV 20B-3, a second class fourth child UAV 20B-4, a second class fifth child UAV 20B-5, a second class sixth child UAV 20B-6, a second class seventh child UAV 20B-7, a second class eighth child UAV 20B-8 and a second class ninth child UAV 20B-9, and the first class child UAV 20A is the first travel point. The mother UAV 10 calculates the nine time difference values between the first response time of the first travel point and the nine second response times, selects the minimum time difference value from the nine time difference values and regards the second class sixth child UAV 20B-6 corresponding to the minimum time difference value as the second travel point.

Due to the existence of the second travel point, the number of the second class child UAVs 20B decreases from nine to eight, and the third travel point is selected from the eight second class child UAVs 20B; namely, M=8, N=3, the second travel point is the current travel point, and the third travel point is the next travel point. The mother UAV 10 calculates the eight time difference values between the second response time of the second travel point and the eight second response times, selects the minimum time difference value from the eight time difference values and regards the second class third child UAV 20B-3 corresponding to the minimum time difference value as the third travel point, and the second class sixth child UAV 20B-6 and the second class third child UAV 20B-3 are set as the connected relay nodes of the UAV network. At present, the mother UAV 10 ensures that the signal coverage range of the second class third child UAV 20B-3 does not include the target base station B2.

And then, M=7, N=4, the third travel point is the current travel point, and the fourth travel point is the next travel point. The mother UAV 10 calculates the seven time difference values between the second response time of the third travel point and the seven second response times, selects the minimum time difference value from the seven time difference values and regards the second class eighth child UAV 20B-8 corresponding to the minimum time difference value as the fourth travel point, and the second class eighth child UAV 20B-8 and the second class third child UAV 20B-3 are set as the connected relay nodes of the UAV network. At present, the mother UAV 10 ensures that the signal coverage range of the second class eighth child UAV 20B-8 does not include the target base station B2. Afterwards, M=6, N=5, the fourth travel point is the current travel point, and the fifth travel point is the next travel point. The mother UAV 10 calculates the six time difference values between the second response time of the fourth travel point and the six second response times, selects the minimum time difference value from the six time difference values and regards the second class second child UAV 20B-2 corresponding to the minimum time difference value as the fifth travel point, and the second class second child UAV 20B-2 and the second class eighth child UAV 20B-8 are set as the connected relay nodes of the UAV network. At present, the mother UAV 10 ensures that the signal coverage range of the second class second child UAV 20B-2 does not include the target base station B2.

Finally, M=5, N=6, the fifth travel point is the current travel point, and the sixth travel point is the next travel point. The mother UAV 10 calculates the five time difference values between the second response time of the fifth travel point and the five second response times, selects the minimum time difference value from the five time difference values and regards the second class fourth child UAV 20B-4 corresponding to the minimum time difference value as the sixth travel point, and the second class fourth child UAV 20B-4 and the second class second child UAV 20B-2 are set as the connected relay nodes of the UAV network. At present, the mother UAV 10 ensures that the signal coverage range of the second class fourth child UAV 20B-4 includes the target base station B2. The mother UAV 10 ensures that the sixth travel point is the last travel point of the travel list, creates the transmission path of the target packet according to the first travel point to the sixth travel point and writes the transmission path of the target packet into the travel list. The transmission path of the target packet in the travel list: the source base station B1->the first class child UAV 20A->the second class sixth child UAV 20B-6->the second class third child UAV 20B-3->the second class eighth child UAV 20B-8->the second class second child UAV 20B-2->the second class fourth child UAV 20B-4->the target base station B2, and the second class sixth child UAV 20B-6, the second class third child UAV 20B-3, the second class eighth child UAV 20B-8, the second class second child UAV 20B-2 and the second class fourth child UAV 20B-4 are all auxiliary UAVs. The aforementioned transmission path of the target packet is exemplarily enumerated instead of limiting the present disclosure.

The less the time difference value is, the shorter the distance between the two second class child UAVs 20B is. By step S41 to step S44, the minimum time difference value is found to ensure that the distance between the two adjacent travel point (e.g., the third travel point and the fourth travel point) is the shortest so that the transmission path of the target packet is optimized. The target packet is efficiently relayed by the multiple sets of the connected relay nodes with the shortest distances to achieve a purpose of saving power.

Step S5: according to the travel list, transmitting the target packet to the target base station B2. Specifically, the mother UAV 10 controls the first class child UAV 20A, the second class sixth child UAV 20B-6, the second class third child UAV 20B-3, the second class eighth child UAV 20B-8, the second class second child UAV 20B-2 and the second class fourth child UAV 20B-4 to collaboratively transmit the target packet to the target base station B2 according to the transmission path of the target packet of the travel list.

In the optimizing method of the packet transmission path of the present embodiment, the corresponding response time of each child UAV is calculated by the corresponding response signal, and the auxiliary UAVs are selected from the plurality of child UAVs according to the difference value between the two corresponding response times of each two child UAVs, and the auxiliary UAVs serve as the travel points of the travel list. By the configuration of the travel list, the purpose of optimizing the transmission path of the target packet is achieved. By optimizing the transmission path of the target packet, the target packet can be efficiently transmitted, and entire power dissipation of the child UAV group can be reduced.

When the optimizing method of the packet transmission path and the UAV network system are applied to monitoring volcanic eruptions, one of the child UAVs shoot the volcanic eruptions to generate videos and generates video packets according to the videos, and the base station where a weather station is located is the target base station. The mother UAV selects the travel points from the child UAVs according to the response times which the plurality of child UAVs takes for responding to the test packet and controls the child UAV which generates the video packets and the travel points to collaboratively transmit the video packets to the target base station in order to achieve the purpose of the immediate transmission of the video packets.

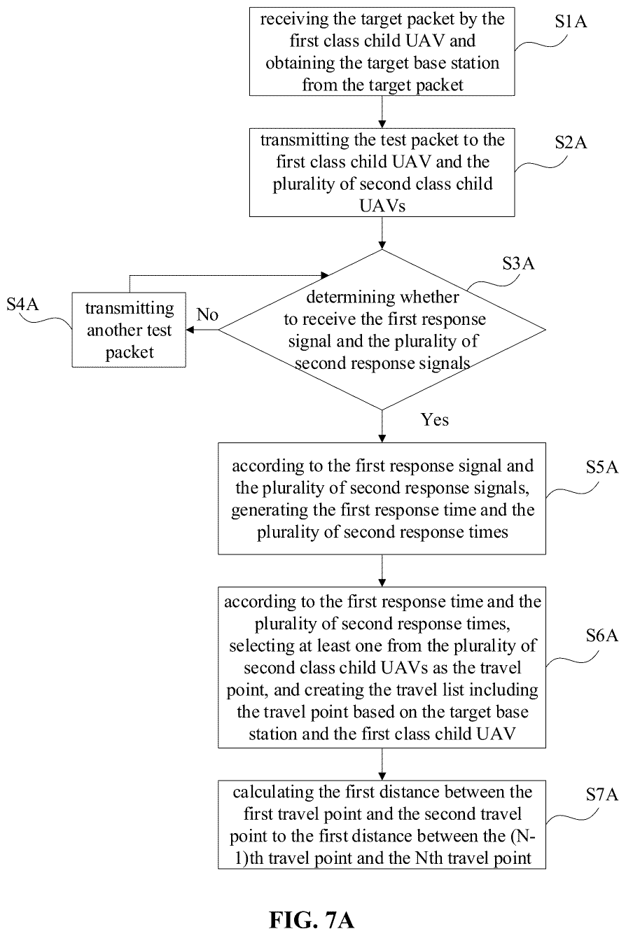

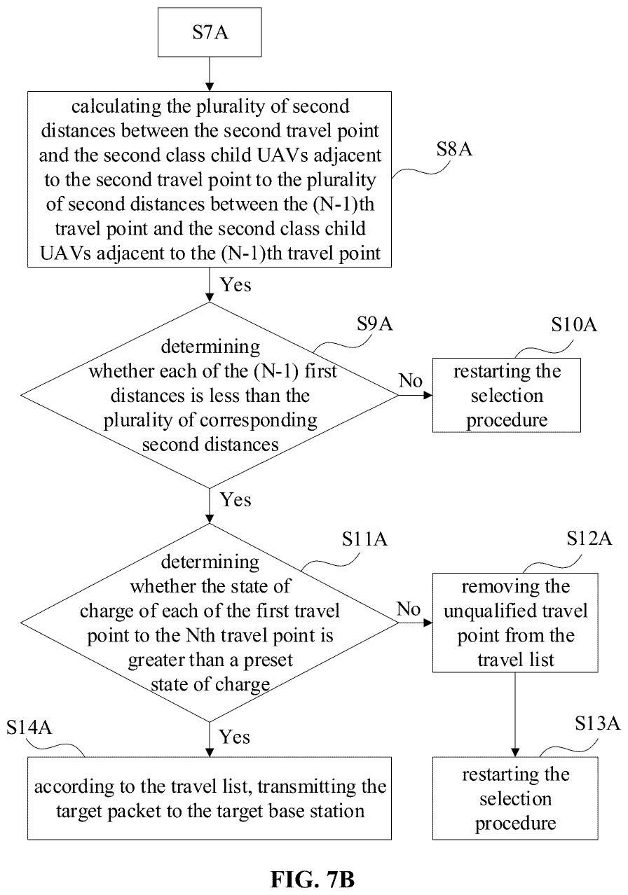

Please refer to FIG. 7A and FIG. 7B, which depict a flowchart of an optimizing method of a packet transmission path according to another embodiment of the present disclosure. As shown in FIG. 7A and FIG. 7B, the optimizing method of the packet transmission path includes step S1A˜step S14A. Step S1A, step S5A, step S6A and step S14A are the same as step S1, step S3, step S4 and step S5 shown in FIG. 3 and would not be repeated. For example, step S2A˜step S4A and step S7A˜step S13A would be explained by the UAV network system shown in FIG. 1 as follows. Step S2A˜step S4A are to determine whether the first class child UAV 20A and each of the plurality of second class child UAVs 20B respectively transmit the first response signal and the corresponding second response signal to the mother UAV 10, step S7A˜step S10A are to determine whether the distance between the adjacent two travel points is the shortest, and step S11A˜step S13A are to determine whether the state of charge of each of the travel points is sufficient.

Step S2A: transmitting the test packet to the first class child UAV 20A and the plurality of second class child UAVs 20B. As described above, the mother UAV 10 transmits the test packet to the first class child UAV 20A and the plurality of second class child UAVs 20B.

Step S3A: determining whether to receive the first response signal and the plurality of second response signals. Specifically, the mother UAV 10 determines whether the first class child UAV 20A and each of the plurality of second class child UAVs 20B respond and transmit the first response signal and the corresponding second response signal according to the test packet to ensure the network connection of the first class child UAV 20A and each of the plurality of second class child UAVs 20B.

When the first class child UAV 20A does not transmit the first response signal to the mother UAV 10 or one of the plurality of second class child UAVs 20B does not transmit the second response signal to the mother UAV 10, the mother UAV 10 determines that the network connection of the first class child UAV 20A which does not transmit the first response signal or the network connection of the second class child UAV which does not transmit the corresponding second response signal is unstable and subsequently performs step S4A. When the first class child UAV 20A transmits the first response signal to the mother UAV 10, and each of the plurality of second class child UAVs 20B transmits the corresponding second response signal to the mother UAV 10, the mother UAV 10 determines that the network connection of the first class child UAV 20A and the network connection of each of the plurality of second class child UAVs 20B are stable and subsequently performs step S5A.

Step S4A: transmitting another test packet. Specifically, the mother UAV 10 transmits another test packet to the first class child UAV 20A and the plurality of second class child UAVs 20B and goes back to step S3A.

Step S7A to step S13A would be described by the travel list shown in FIG. 6 as follows.

Step S7A: calculating the first distance between the first travel point and the second travel point to the first distance between the (N-1)th travel point and the Nth travel point. Specifically, the distance between the two adjacent travel points of each of the multiple sets of the connected relay nodes is the first distance, and the mother UAV 10 calculates the corresponding first distance of each set of the connected relay nodes. For example, the first travel point to the sixth travel point are grouped into five sets of the connected relay nodes, the first travel point and the second travel point constitute a first set of connected relay nodes, the second travel point and the third travel point constitute a second set of connected relay nodes, the third travel point and the fourth travel point constitute a third set of connected relay nodes, the fourth travel point and the fifth travel point constitute a fourth set of connected relay nodes, the fifth travel point and the sixth travel point constitute a fifth set of connected relay nodes, and the first set of connected relay nodes to the fifth set of connected relay nodes correspond to the five first distances.

Step S8A: calculating the plurality of second distances between the second travel point and the second class child UAVs 20B adjacent to the second travel point to the plurality of second distances between the (N-1)th travel point and the second class child UAVs 20B adjacent to the (N-1)th travel point. Due to the configurations of the plurality of child UAVs 20, each of the second travel point to the (N-1)th travel point has the adjacent second class child UAVs 20B in the surroundings thereof. The number of the second class child UAVs 20B adjacent to the second travel point to the number of the second class child UAVs 20B adjacent to the (N-1)th travel point may be multiple, and the number of the second distances corresponding to the second travel point to the number of the second distances corresponding to the (N-1)th travel point are multiple.

For example, as shown in FIG. 6, the number of the second class child UAVs 20B adjacent to the second travel point (i.e., the second class sixth child UAV 20B-6) to the number of the second class child UAVs 20B adjacent to the fifth travel point (i.e., the second class second child UAV 20B-2) are all two, and the number of the second distances corresponding to the second travel point to the number of the second distances corresponding to the fifth travel point are all two.

Step S9A: determining whether each of the (N-1) first distances is less than the plurality of corresponding second distances. Specifically, the mother UAV 10 determines whether the first distance of each of the second travel point to the (N-1)th travel point is less than the corresponding second distances to ensure that the first distance of each of the second travel point to the (N-1)th travel point is the shortest.

The third travel point (i.e., the second class third child UAV 20B-3) would be taken as an example to specifically describe step S9A and step S10A as follows, and the operation mechanisms of the second travel point, the fourth travel point and the fifth travel point at step S9A and step 10A are the same as the operation mechanism of the third travel point at step S9A and step 10A and would not be repeated.

When determining that the first distance of the third travel point is less than the corresponding two second distances, the mother UAV 10 subsequently performs step S11A. When determining that the first distance of the third travel point is not less than the corresponding two second distances, the mother UAV 10 subsequently performs step S10A.

Step S10A: restarting the selection procedure. Because the first distance of the third travel point is not less than one of the corresponding two second distances, the mother UAV 10 determines the third travel point as an unqualified travel point, and the third travel point to the sixth travel point require replanning. Afterwards, the mother UAV 10 restarts performing step S441 to step S445 according to the second travel point (i.e., the second class sixth child UAV 20B-6) to obtain a new third travel point to a new sixth travel point.

Step S11A: determining whether the state of charge of each of the first travel point to the Nth travel point is greater than a preset state of charge. Specifically, the mother UAV 10 determines whether the state of charge of each of the first travel point to the Nth travel point is sufficient to transmit the target packet.

The third travel point (i.e., the second class third child UAV 20B-3) would be taken as an example to specifically describe step S11A to step S13A as follows, and the operation mechanisms of the second travel point, the fourth travel point and the fifth travel point at step S11A to step S13A are the same as the operation mechanism of the third travel point at step S11A to step S13A and would not be repeated.

When determining that the state of charge of the third travel point is less than the preset state of charge, the mother UAV 10 determines that the state of charge of the third travel point is insufficient, labels the third travel point as the unqualified travel point and subsequently performs step S12A. When determining that the state of charge of the third travel point is greater than the preset state of charge, the mother UAV 10 determines that the state of charge of the third travel point is sufficient and subsequently performs step S14A.

Step S12A: removing the unqualified travel point from the travel list. Specifically, the mother UAV 10 removes the third travel point from the travel list.

Step S13A: restarting the selection procedure. Because the third travel point is the unqualified travel point, the mother UAV 10 needs to restarts selecting the third travel point. Afterward, the mother UAV 10 restarts performing step S441 to step S445 according to the second travel point (i.e., the second class sixth child UAV 20B-6) to obtain a new third travel point. Thereafter, the mother UAV 10 determines whether the first distance between the third travel point and the second travel point is less than the corresponding two distances and the first distance between the fourth travel point and the third travel point is less than the corresponding two distances.

When determining that the first distance between the third travel point and the second travel point is less than the corresponding two distances and the first distance between the fourth travel point and the third travel point is less than the corresponding two distances, the mother UAV 10 writes the new third travel point into the travel list. When determining that the first distance between the third travel point and the second travel point is not less than the corresponding two distances or the first distance between the fourth travel point and the third travel point is not less than the corresponding two distances, the mother UAV 10 restarts performing step S441 to step S445 according to the second travel point (i.e., the second class sixth child UAV 20B-6) to obtain a new third travel point to a new sixth travel point.

In the optimizing method of the packet transmission path of the present embodiment, whether the transmission path of the target packet in the travel points is the shortest transmission path of the target packet is further determined, and the child UAV that the state of charge is insufficient is removed from the travel list, and the travel points of the travel list are renewed, thereby achieving the purpose of optimizing the travel list.

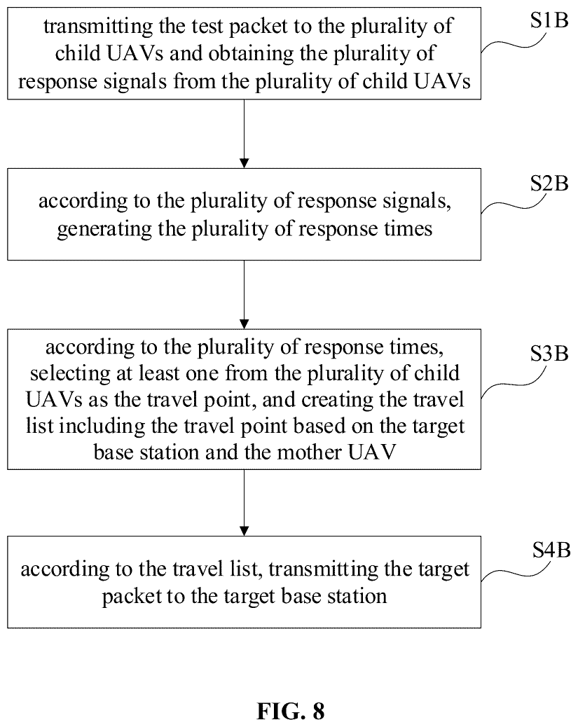

Please refer to FIG. 8, which depicts a flowchart of an optimizing method of a packet transmission path according to yet another embodiment of the present disclosure. As shown in FIG. 8, the optimizing method of the packet transmission path includes step S1B˜step S4B, and step S4B is the same as step S5 shown in FIG. 3 and would not be repeated. The optimizing method of the packet transmission path shown in FIG. 8 may be applicable to the UAV network system shown in FIG. 2 but is not limited thereto. For example, step S1B˜step S4B would be explained by the UAV network system shown in FIG. 2 as follows.

It should be noted that the optimizing method of the packet transmission path shown in FIG. 8 is planned for the situation of receiving the target packet by the mother UAV 10 and there is no need to distinguish the plurality of child UAVs 20 by the first class and the second class.

Step S1B: transmitting the test packet to the plurality of child UAVs 20 and obtaining the plurality of response signals from the plurality of child UAVs 20. Specifically, the mother UAV 10 transmits the test packet to the plurality of child UAVs 20, and the plurality of child UAVs 20 respectively transmit the plurality of response signals to the mother UAV 10 in response to the mother UAV 10 after receiving the test packet, and the mother UAV 10 ensures the network connection of the plurality of child UAVs 20 according to the plurality of response signals.

When one of the plurality of child UAVs 20 does not transmit the response signal to the mother UAV 10, the mother UAV 10 transmits another test packet to the plurality of child UAVs 20 and determines whether each of the plurality of child UAVs 20 generates the response signal according to the another test packet again.

Step S2B: according to the plurality of response signals, generating the plurality of response times. Specifically, the time point when the mother UAV 10 transmits the test packet is the transmission time point, the plurality of time points when the mother UAV 10 receives the plurality of response signals are a plurality of receiving time points, and the mother UAV 10 performs the subtraction on the plurality of receiving time points and the transmission time point respectively to generate the plurality of response times.

Step S3B: according to the plurality of response times, selecting at least one from the plurality of child UAVs 20 as the travel point, and creating the travel list including the travel point based on the target base station B2 and the mother UAV 10. Specifically, the mother UAV 10 is the first travel point of the travel list (i.e., the starting point of the travel list). The mother UAV 10 selects the minimum response time from the plurality of response times and regards the child UAV 20 with the minimum response time as the second travel point. Afterwards, the mother UAV 10 selects one from the plurality of class child UAVs 20 except the second travel point as a third travel point according to the response time of the second travel point, and selects one from the plurality of class child UAVs 20 except the second travel point and the third travel point as a fourth travel point according to the response time of the third travel point. The selection mechanisms of the fifth travel point to the last travel point are the same as the selection mechanisms of the second travel point to the fourth travel point and would not be repeated. Finally, the mother UAV 10 determines whether the signal coverage range of the last travel point (i.e., the ending point of the travel list) includes the target base station B2, and the operation mechanism of determining whether the signal coverage range of the last travel point includes the target base station B2 has been described in the paragraphs corresponding to step S4 of FIG. 3 and would not be repeated.

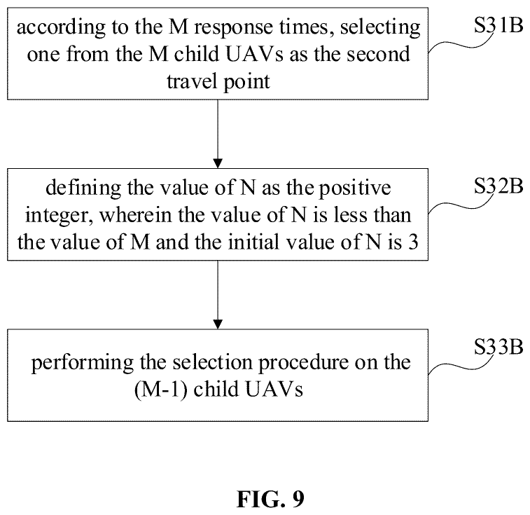

The following would describe the steps of selecting travel points in details. Please refer to FIG. 9, which depicts a flowchart of detailed steps of selecting travel points according to yet another embodiment of the present disclosure. As shown in FIG. 9, the detailed steps of selecting the travel points includes step S31B˜step S33B, and step S31B˜step S33B are performed by the mother UAV 10. Herein, the number of the plurality of class child UAVs 20 is M, the value of M is defined as a positive integer, and the travel list includes N travel points.

Step S31B: according to the M response times, selecting one from the M child UAVs 20 as the second travel point. Specifically, the mother UAV 10 selects the minimum response time from the M response times and regards the child UAV 20 with the minimum response time as the second travel point.

Step S32B: defining the value of N as the positive integer, wherein the value of N is less than the value of M and the initial value of N is 3. In light of the configuration of the mother UAV 10 (i.e., the first travel point) and the second travel point, the mother UAV 10 performs the selection of the travel points from the third travel point.

Step S33B: performing the selection procedure on the (M-1) child UAVs. Specifically, the mother UAV 10 performs the selection procedure on each of the (M-1) child UAVs 20 to select the third travel point to the Nth travel point from the (M-1) child UAVs 20. The detailed steps of the selection procedure is the same as the detailed steps of the selection procedure in FIG. 5, and the only one difference between them is the (M-1) second class child UAVs 20 and the (M-1) child UAVs 20, and herein, the detailed steps of the selection procedure would be not repeated.

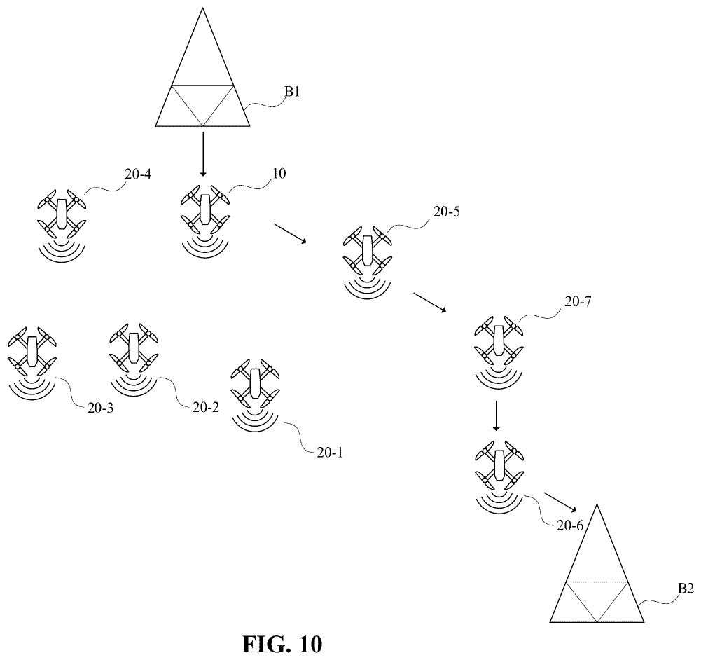

For example, as shown in FIG. 10, M=7, the seven child UAVs 20 is a first child UAV 20-1, a second child UAV 20-2, a third child UAV 20-3, a fourth child UAV 20-4, a fifth child UAV 20-5, a sixth child UAV 20-6, a seventh child UAV 20-7, and the mother UAV 10 is the first travel point. The mother UAV 10 selects the minimum response time from the seven response times and regards the fifth child UAV 20-5 with the minimum response time as the second travel point.

Afterwards, M=7, N=3, the second travel point is the current travel point, and the third travel point is the next travel point. The mother UAV 10 calculates the six time difference values between the response time of the second travel point and the six second response times, selects the minimum time difference value from the six time difference values and regards the seventh child UAV 20-7 corresponding to the minimum time difference value as the third travel point, and the seventh child UAV 20-7 and the fifth child UAV 20-5 are set as the connected relay nodes of the UAV network. At present, the mother UAV 10 ensures that the signal coverage range of the seventh child UAV 20-7 does not include the target base station B2.

Finally, M=7, N=3, the third travel point is the current travel point, and the fourth travel point is the next travel point. The mother UAV 10 calculates the five time difference values between the response time of the third travel point and the five second response times, selects the minimum time difference value from the five time difference values and regards the sixth child UAV 20-6 corresponding to the minimum time difference value as the fourth travel point. At present, the mother UAV 10 ensures that the signal coverage range of the sixth child UAV 20-6 includes the target base station B2. The mother UAV 10 ensures the fourth travel point is the last travel point of the travel list, creates the transmission path of the target packet according to the first travel point to the fourth travel point and writes the transmission path of the target packet into the travel list. The transmission path of the target packet in the travel list: the source base station B1->the mother UAV 10->the fifth child UAV 20-5->the seventh child UAV 20-7->the sixth child UAV 20-6->target base station B2, and the fifth child UAV 20-5, the seventh child UAV 20-7 and the sixth child UAV 20-6 are all auxiliary UAVs.

In the optimizing method of the packet transmission path of the present embodiment, planning the transmission path of the target packet to create the travel list when the mother UAV 10 receives the target packet is further elaborated. By the configuration of the travel list, the shortest transmission path of the target packet is obtained, thereby achieving the purpose of saving power.

In view of the above description, the UAV network system and the optimizing method of the packet transmission path selects at least one child UAV as the travel point according to the plurality of response times which the plurality of child UAVs takes for responding to the mother UAV, creates the travel list according to the travel point and the child UAV receiving the packet or the mother UAV and transmits the packets to a destination according to the travel point of the travel list. By the configuration of the travel list, the entire power dissipation of the UAV group may be reduced, and the immediate transmission of the packets may be implemented.

In addition, the UAV network system and the optimizing method of the packet transmission path may be applied to a disaster relief environment so that the base station where disaster relief workers are located may access the situation of the disaster relief environment.

What is claimed is:

1. An UAV network system comprising:
a child UAV group comprising a first class child UAV and a plurality of second class child UAVs, wherein the first class child UAV receives a target packet, and the first class child UAV and the plurality of second class child UAVs are wirelessly connected to each other;
a mother UAV wirelessly connected to the first class child UAV and the plurality of second class child UAVs and obtaining a target base station from the target packet by the first class child UAV, and the mother UAV performing steps as follows:
transmitting a test packet to the first class child UAV and the plurality of second class child UAVs and obtaining a first response signal and a plurality of second response signals from the first class child UAV and the plurality of second class child UAVs;
according to the first response signal and the plurality of second response signals, generating a first response time and a plurality of second response times;
according to the first response time and the plurality of second response times, selecting at least one from the plurality of second class child UAVs as a travel point, and creating a travel list comprising the travel point based on the target base station and the first class child UAV; and
according to the travel list, transmitting the target packet to the target base station.

2. The UAV network system according to claim 1, wherein when the first class child UAV does not transmit the first response signal to the mother UAV or one of the plurality of second class child UAVs does not transmit the second response signal to the mother UAV, the mother UAV transmits another test packet to the first class child UAV and the plurality of second class child UAVs.

3. The UAV network system according to claim 1, wherein a time point when the mother UAV transmits the test packet is a transmission time point, a time point when the mother UAV receives the first response signal and a plurality of time points when the mother UAV receives the plurality of second response signals are a first receiving time point and a plurality of second receiving time points, the step of generating the first response time and the plurality of second response times according to the first response signal and the plurality of second response signals by the mother UAV comprises:
performing subtraction on the first receiving time point and the transmission time point to generate the first response time; and
performing subtraction on the plurality of second receiving time points and the transmission time point respectively to generate the plurality of second response times.

4. The UAV network system according to claim 1, wherein a number of the plurality of second class child UAVs is M, a value of M is defined as a positive integer, the first class child UAV serves as a first travel point of the travel list, and the step of selecting at least one from the plurality of second class child UAVs as the travel point according to the first response time and the plurality of second response times and creating the travel list comprising the travel point based on the target base station and the first class child UAV by the mother UAV comprises:
calculating M time difference values between the first response time and the M second response times;
according to the M time difference values, selecting one from the M second class child UAVs as a second travel point;
defining a value of N as the positive integer, wherein the value of N is less than the value of M and an initial value of Nis 3; and
performing a selection procedure on the (M-1) second class child UAVs, and the selection procedure comprising:
calculating (M−1) time difference values between the second response time of a (N−1) th travel point and the (M−1) second response times;
according to the (M−1) time difference values, selecting one from the (M−1) second class child UAVs as a Nth travel point;
determining whether a signal coverage range of the Nth travel point comprises the target base station;
when determining that the signal coverage range of the Nth travel point does not comprise the target base station, adding 1 to the value of N and subtracting 1 from the value of M, and performing the selection procedure again;
when determining that the signal coverage range of the Nth travel point comprises the target base station, creating the travel list according to the first travel point and the second travel point to the Nth travel point.

5. The UAV network system according to claim 4, wherein the mother UAV further performs steps as follows:
calculating a first distance between the first travel point and the second travel point to a first distance between the (N−1)th travel point and the Nth travel point;
calculating a plurality of second distances between the second travel point and the second class child UAVs adjacent to the second travel point to a plurality of second distances between the (N−1)th travel point and the second class child UAVs adjacent to the (N−1)th travel point;
determining whether each of the (N−1) first distances is less than the plurality of corresponding second distances;
when determining that the first distance is not less than one of the plurality of corresponding second distances, labelling the travel point that the first distance is less than the corresponding second distance as an unqualified travel point, and transmitting a request signal to the unqualified travel point to facilitate the unqualified travel point to restart the selection procedure.

6. The UAV network system according to claim 4, wherein the mother UAV further performs steps as follows:
determining whether a state of charge of each of the first travel point to the Nth travel point is greater than a preset state of charge;
when determining that the state of charge is not greater than the preset state of charge, labelling the travel point that the state of charge is not greater than the preset state of charge as an unqualified travel point, and removing the unqualified travel point from the travel list.

7. The UAV network system according to claim 1, wherein the target packet is from a source base station, and the mother UAV receives a test signal from the source base station to obtain a timestamp and selects one from the plurality of second class child UAVs as the first class child UAV according to the timestamp.

8. The UAV network system according to claim 1, wherein the child UAV group and the mother UAV collaboratively form a UAV network and serve as relay stations of the UAV network.

9. An UAV network system comprising:
a plurality of child UAVs wirelessly connected to each other;
a mother UAV wirelessly connected to the plurality of child UAVs and receiving a target packet and obtaining a target base station from the target packet, and the mother UAV performing steps as follows:
transmitting a test packet to the plurality of child UAVs and obtaining a plurality of response signals from the plurality of child UAVs;
according to the plurality of response signals, generating a plurality of response times;
according to the plurality of response times, selecting at least one from the plurality of child UAVs as a travel point, and creating a travel list comprising the travel point based on the target base station and the mother UAV; and
according to the travel list, transmitting the target packet to the target base station.

10. The UAV network system according to claim 9, wherein when one of the plurality of child UAVs does not transmit the response signal to the mother UAV, the mother UAV transmits another test packet to the plurality of child UAVs.

11. The UAV network system according to claim 9, wherein a time point when the mother UAV transmits the test packet is a transmission time point, a plurality of time points when the mother UAV receives the plurality of response signals are a plurality of receiving time points, the step of generating the plurality of response times according to the plurality of response signals by the mother UAV comprises:
performing subtraction on the plurality of receiving time points and the transmission time point respectively to generate the plurality of response times.

12. The UAV network system according to claim 9, wherein a number of the plurality of child UAVs is M, a value of M is defined as a positive integer, the mother UAV serves as a first travel point of the travel list, and the step of selecting at least one from the plurality of child UAVs as the travel point according to the plurality of response times and creating the travel list comprising the travel point based on the target base station and the mother UAV by the mother UAV comprises:
according to the M response times, selecting one from the M child UAVs as a second travel point;
defining a value of N as the positive integer, wherein the value of N is less than the value of M and an initial value of N is 3; and
performing a selection procedure on the (M−1) child UAVs, and the selection procedure comprising:
calculating (M−1) time difference values between the response time of a (N−1)th travel point and the (M−1) response times;
according to the (M−1) time difference values, selecting one from the (M−1) child UAVs as a Nth travel point;
determining whether a signal coverage range of the Nth travel point comprises the target base station;
when determining that the signal coverage range of the Nth travel point does not comprise the target base station, adding 1 to the value of N and subtracting 1 from the value of M, and performing the selection procedure again;
when determining that the signal coverage range of the Nth travel point comprises the target base station, creating the travel list according to the first travel point and the second travel point to the Nth travel point.

13. The UAV network system according to claim 12, wherein the mother UAV further performs steps as follows:
calculating a first distance between the first travel point and the second travel point to a first distance between the (N−1)th travel point and the Nth travel point;
calculating a plurality of second distances between the second travel point and the child UAVs adjacent to the second travel point to a plurality of second distances between the (N−1)th travel point and the child UAVs adjacent to the (N−1)th travel point;
determining whether each of the (N−1) first distances is less than the plurality of corresponding second distances;
when determining that the first distance is not less than one of the plurality of corresponding second distances, labelling the travel point that the first distance is less than the corresponding second distance as an unqualified travel point, and transmitting a request signal to the unqualified travel point to facilitate the unqualified travel point to restart the selection procedure.

14. The UAV network system according to claim 12, wherein the mother UAV further performs steps as follows:
determining whether a state of charge of each of the first travel point to the Nth travel point is greater than a preset state of charge;
when determining that the state of charge is not greater than the preset state of charge, labelling the travel point that the state of charge is not greater than the preset state of charge as an unqualified travel point, and removing the unqualified travel point from the travel list.

15. The UAV network system according to claim 9, wherein the plurality of child UAVs and the mother UAV collaboratively form a UAV network and serve as relay stations of the UAV network.

16. An optimizing method of a packet transmission path adapted to a UAV network system, wherein the UAV network system comprises a mother UAV and a child UAV group comprising a first class child UAV and a plurality of second class child UAVs, and the optimizing method of the packet transmission path performed by the mother UAV comprising:
receiving a target packet by the first class child UAV and obtaining a target base station from the target packet;
transmitting a test packet to the first class child UAV and the plurality of second class child UAVs and obtaining a first response signal and a plurality of second response signals from the first class child UAV and the plurality of second class child UAVs;
according to the first response signal and the plurality of second response signals, generating a first response time and a plurality of second response times;
according to the first response time and the plurality of second response times, selecting at least one from the plurality of second class child UAVs as a travel point, and creating a travel list comprising the travel point based on the target base station and the first class child UAV; and
according to the travel list, transmitting the target packet to the target base station.

17. The optimizing method of the packet transmission path according to claim 16, further comprising:
when the first class child UAV does not transmit the first response signal to the mother UAV or one of the plurality of second class child UAVs does not transmit the second response signal to the mother UAV, transmitting another test packet to the first class child UAV and the plurality of second class child UAVs.

18. The optimizing method of the packet transmission path according to claim 16, wherein a time point when the mother UAV transmits the test packet is a transmission time point, a time point when the mother UAV receives the first response signal and a plurality of time points when the mother UAV receives the plurality of second response signals are a first receiving time point and a plurality of second receiving time points, the step of generating the first response time and the plurality of second response times according to the first response signal and the plurality of second response signals comprises:
performing subtraction on the first receiving time point and the transmission time point to generate the first response time; and
performing subtraction on the plurality of second receiving time points and the transmission time point respectively to generate the plurality of second response times.

19. The optimizing method of the packet transmission path according to claim 16, wherein a number of the plurality of second class child UAVs is M, a value of M is defined as a positive integer, the first class child UAV serves as a first travel point of the travel list, and the step of selecting at least one from the plurality of second class child UAVs as the travel point according to the first response time and the plurality of second response times and creating the travel list comprising the travel point based on the target base station and the first class child UAV comprises:
calculating M time difference values between the first response time and the M second response times;
according to the M time difference values, selecting one from the M second class child UAVs as a second travel point;
defining a value of N as the positive integer, wherein the value of N is less than the value of M and an initial value of Nis 3; and
performing a selection procedure on the (M−1) second class child UAVs, and the selection procedure comprising:
calculating (M−1) time difference values between the second response time of a (N−1) th travel point and the (M−1) second response times;
according to the (M−1) time difference values, selecting one from the (M−1) second class child UAVs as a Nth travel point;
determining whether a signal coverage range of the Nth travel point comprises the target base station;
when determining that the signal coverage range of the Nth travel point does not comprise the target base station, adding 1 to the value of N and subtracting 1 from the value of M, and performing the selection procedure again;
when determining that the signal coverage range of the Nth travel point comprises the target base station, creating the travel list according to the first travel point and the second travel point to the Nth travel point.

20. The optimizing method of the packet transmission path according to claim 19, further comprising:
calculating a first distance between the first travel point and the second travel point to a first distance between the (N−1)th travel point and the Nth travel point;
calculating a plurality of second distances between the second travel point and the second class child UAVs adjacent to the second travel point to a plurality of second distances between the (N−1)th travel point and the second class child UAVs adjacent to the (N−1)th travel point;
determining whether each of the (N−1) first distances is less than the plurality of corresponding second distances;
when determining that the first distance is not less than one of the plurality of corresponding second distances, labelling the travel point that the first distance is less than the corresponding second distance as an unqualified travel point, and transmitting a request signal to the unqualified travel point to facilitate the unqualified travel point to restart the selection procedure.

21. The optimizing method of the packet transmission path according to claim 19, further comprising:
determining whether a state of charge of each of the first travel point to the Nth travel point is greater than a preset state of charge;
when determining that the state of charge is not greater than the preset state of charge, labelling the travel point that the state of charge is not greater than the preset state of charge as an unqualified travel point, and removing the unqualified travel point from the travel list.

22. An optimizing method of a packet transmission path adapted to a UAV network system, wherein the UAV network system comprises a mother UAV and a plurality of child UAVs, and the optimizing method of the packet transmission path performed by the mother UAV comprising:
receiving a target packet and obtaining a target base station from the target packet;
transmitting a test packet to plurality of child UAVs and obtaining a plurality of response signals from the plurality of child UAVs;
according to the plurality of response signals, generating a plurality of response times;
according to the plurality of response times, selecting at least one from the plurality of child UAVs as a travel point, and creating a travel list comprising the travel point based on the target base station and the mother UAV; and
according to the travel list, transmitting the target packet to the target base station.

23. The optimizing method of the packet transmission path according to claim 22, further comprising:
when one of the plurality of child UAVs does not transmit the response signal to the mother UAV, transmitting another test packet to the plurality of child UAVs.

24. The optimizing method of the packet transmission path according to claim 22, wherein a time point when the mother UAV transmits the test packet is a transmission time point, a plurality of time points when the mother UAV receives the plurality of response signals are a plurality of receiving time points, the step of generating the plurality of response times according to the plurality of response signals comprises:
performing subtraction on the plurality of receiving time points and the transmission time point respectively to generate the plurality of response times.

25. The optimizing method of the packet transmission path according to claim 22, wherein a number of the plurality of child UAVs is M, a value of M is defined as a positive integer, the mother UAV serves as a first travel point of the travel list, and the step of selecting at least one from the plurality of child UAVs as the travel point according to the plurality of response times and creating the travel list comprising the travel point based on the target base station and the mother UAV by the mother UAV comprises:
according to the M response times, selecting one from the M child UAVs as a second travel point;
defining a value of N as the positive integer, wherein the value of N is less than the value of M and an initial value of N is 3; and
performing a selection procedure on the (M−1) child UAVs, and the selection procedure comprising:
calculating (M−1) time difference values between the response time of a (N−1)th travel point and the (M−1) response times;
according to the (M−1) time difference values, selecting one from the (M−1) child UAVs as a Nth travel point;
determining whether a signal coverage range of the Nth travel point comprises the target base station;
when determining that the signal coverage range of the Nth travel point does not comprise the target base station, adding 1 to the value of N and subtracting 1 from the value of M, and performing the selection procedure again;
when determining that the signal coverage range of the Nth travel point comprises the target base station, creating the travel list according to the first travel point and the second travel point to the Nth travel point.

26. The optimizing method of the packet transmission path according to claim 25, further comprising:
calculating a first distance between the first travel point and the second travel point to a first distance between the (N−1)th travel point and the Nth travel point;
calculating a plurality of second distances between the second travel point and the second class child UAVs adjacent to the second travel point to a plurality of second distances between the (N−1)th travel point and the second class child UAVs adjacent to the (N−1)th travel point;
determining whether each of the (N−1) first distances is less than the plurality of corresponding second distances;
when determining that the first distance is not less than one of the plurality of corresponding second distances, labelling the travel point that the first distance is less than the corresponding second distance as an unqualified travel point, and transmitting a request signal to the unqualified travel point to facilitate the unqualified travel point to restart the selection procedure.

27. The optimizing method of the packet transmission path according to claim 25, further comprising:
determining whether a state of charge of each of the first travel point to the Nth travel point is greater than a preset state of charge;
when determining that the state of charge is not greater than the preset state of charge, labelling the travel point that the state of charge is not greater than the preset state of charge as an unqualified travel point, and removing the unqualified travel point from the travel list.
